(19) United States
(12) Patent Application Publication
(10) Pub. No.: US 2025/0353285 A1
(43) Pub. Date: Nov. 20, 2025

(54) METHOD OF DETERMINING SEWING PATTERN OF EPIDERMIS-BONDED PRODUCT AND PRODUCTION METHOD

(71) Applicant: Japan Plastics Technologies Co., Ltd., Aichi (JP)

(72) Inventors: Michikazu SHIMA, Aichi (JP); Mamoru YOKOYAMA, Aichi (JP)

(73) Assignee: Japan Plastics Technologies Co., Ltd., Aichi (JP)

(21) Appl. No.: 18/874,747

(22) PCT Filed: Jun. 12, 2023
(86) PCT No.: PCT/JP2023/021798

§ 371 Date: Dec. 13, 2024

(30) Foreign Application Priority Data
Jun. 14, 2022 (JP) 2022-095984

(51) Int. Cl. B32B 37/10; B29C 63/00; B29C 63/02; B32B 38/00; B32B 41/00

(52) U.S. Cl. CPC B32B 37/1018; B29C 63/0052; B29C 63/0073; B29C 63/02; B32B 38/0004; B32B 41/00; B32B 2038/008

(57) ABSTRACT

[Problem] To provide a cover bonding product fabrication method with which it is possible to perform complex sewing such as zigzag stitching, double stitching, and embroidery with a pattern sewing machine via automated operation, regardless of the size of a curved surface of the cover bonding product. [Solution] According to the present invention, a method for determining a sewing pattern on a base material includes: (1) an analysis step for measuring and analyzing an expansion rate of a cover when the cover is vacuum-formed on the base material; (2) a specifying step for specifying, on the basis of the measured expansion rate, a range where the expansion rate is 130% or lower; and (3) a sewing pattern determination step for determining a sewing pattern in the range where the expansion rate is 130% or lower.

### TECHNICAL FIELD

The present invention relates to a method of determining a sewing pattern in producing an epidermis-bonded product in which an epidermis provided with a sewing pattern is bonded to a base material made of plastic, wood, or another hard material, and a method of producing the epidermis-bonded product.

### BACKGROUND ART

In the related art, in the case of producing an epidermis-bonded product in which an epidermis having a sewing pattern is bonded to plastic, wood, or the like, the epidermis-bonded product has been produced by the following steps.

First, the epidermis to be bonded is molded by vacuum molding or the like so as to be adjusted to the form of the base material on which the epidermis is to be attached. After an unnecessary portion of the outer periphery of the molded epidermis is cut (trimmed), a sewing pattern for decoration is manually sewn to the epidermis to prepare an epidermis to which the sewing pattern is applied. On the other hand, an adhesive is applied to the surface of the base material in order to bond the epidermis, and the base material is dried. Then, the epidermis is bonded to the base material by pressure bonding, and the epidermis protruding from the base material is wound, thereby completing the epidermis-bonded product.

In the conventional method of producing an epidermis-bonded product, since the epidermis has already been molded in the step of sewing the sewing pattern, the sewing pattern has to be manually sewed. Therefore, a skilled operator is required for sewing the sewing pattern, so that there is a problem that the production speed is slow, and the cost is high. Furthermore, since a portion having a strong curve cannot be installed on the table of the sewing machine, there is a problem that sewing cannot be performed on such a face in the first place. In addition, regardless of the magnitude of the curve, there is also a problem that even a skilled operator cannot perform the zigzag stitching, the double stitching, the embroidering, and the like, or it is very difficult to perform the stitching. In addition, in the case of the conventional production method, there is a problem that it is necessary to press the epidermis on the base material after molding the epidermis, and the number of steps increases.

Therefore, the present inventors have proposed a method for producing an epidermis-bonded product, the method including the following steps:
(1) an epidermis sewing step of sewing the sewing pattern to the epidermis;
(2) an adhesive application step of applying an adhesive to the base material;
(3) a bonding step of bonding an epidermis to the base material by vacuum molding; and
(4) an epidermis trimming step of cutting the periphery of the epidermis in accordance with the form of the base material

### (Patent Literature 1).

However, in such a producing method, since vacuum molding is performed after sewing is performed, there is a problem that the sewing hole is enlarged or sometimes the sewing hole is broken in a portion having a high expansion rate at the time of vacuum molding.

### CITATION LIST

### Patent Literature

Patent Literature 1: JP2021-105231 A

### SUMMARY OF INVENTION

### Technical Problem

Therefore, the present invention has been made to solve the above-described problems, and it is an object of the present invention to provide a sewing pattern determination method and an epidermis-bonded product producing method capable of reducing expansion of a sewing hole of a sewing pattern and reducing deformation and positional deviation of the sewing pattern even when vacuum molding is performed after the sewing pattern is provided on the epidermis in a raw fabric stage.

### Solution to Problems

In order to solve the above problems, the present invention employs the following means.

A method of determining a sewing pattern to be provided on an epidermis raw fabric before molding when producing a product in which an epidermis provided with a sewing pattern on a base material is integrated by vacuum molding according to the present invention is a sewing pattern determination method including the following steps:
(1) an analysis step of measuring and analyzing the expansion rate of the epidermis when the epidermis is vacuum-molded on the base material by simulation analysis using a computer or by vacuum molding according to each base material installation direction of the vacuum molding;
(2) an identification step of identifying a range of an expansion rate of 130% or less according to each base material installation direction based on the measured expansion rate; and
(3) a sewing pattern determination step of determining a sewing pattern and a base material installation direction within a range of an expansion rate of 130% or less.

In the method of determining a sewing pattern according to the present invention, a state in which an epidermis is vacuum-molded on a predetermined base material is subjected to simulation analysis by a computer or to vacuum molding to measure an expansion rate of the epidermis. At this time, the expansion rate of the epidermis in each case is also measured according to the base material installation direction. Based on the measurement result, a range in which the expansion rate of the epidermis is 130% or less is identified. Then, the arrangement of the base material in the vacuum molding die can be determined and the sewing pattern can be determined by determining the angle in the base material installation direction and the sewing pattern in the vacuum molding within the expansion rate of 130% or less. As a result, since the expansion rate of the portion with the sewing pattern at the time of vacuum molding is suppressed to 130% or less, it is possible to reduce problems such as enlargement of the sewing hole and breakage of the sewing hole.

Further, a method of determining a sewing pattern to be provided on an epidermis raw fabric before molding when producing a product in which an epidermis provided with a sewing pattern on a base material is integrated by vacuum molding according to the present invention is a sewing pattern determination method including the following steps:
(1) an analysis step of measuring and analyzing the expansion rate of the epidermis when the epidermis is vacuum-molded on the base material by simulation analysis using a computer or by vacuum molding according to each base material installation direction of the vacuum molding;
(2) an identification step of identifying a range of an expansion rate of 110% or less according to each base material installation direction based on the measured expansion rate; and
(3) a sewing pattern determination step of determining a sewing pattern and a base material installation direction within a range of an expansion rate of 110% or less.

The arrangement of the base material in the vacuum molding die is determined and the sewing pattern is determined by determining the angle in the base material installation direction and the sewing pattern in the vacuum molding in which the expansion rate is within a range of 110% or less. As a result, as compared with the case where the sewing pattern is provided in the above-described range of the expansion rate of 130% or less, it is possible to further reduce the problem that the sewing hole is enlarged or the sewing hole is broken, and to further reduce the deformation of the sewing pattern.

Furthermore, the sewing pattern determination method according to the present invention may include a verification step of preparing a vacuum molding die based on the base material installation direction after determining the base material installation direction, and verifying the epidermis by actual vacuum molding.

This is a step of preparing a vacuum molding die based on the base material installation direction derived by simulation analysis of a computer, and then verifying the expansion rate by vacuum molding an actual epidermis using this vacuum molding die. By such a step, an error from the expansion rate by computer simulation can be calculated, and a method of producing the epidermis-bonded product described later can be determined with higher accuracy.

In addition, the method of producing an epidermis-bonded product according to the present invention is a method of producing an epidermis-bonded product according to a sewing pattern determined by the sewing pattern determination method described above, the method including the following steps:
(1) an epidermis sewing step of sewing the sewing pattern to a raw fabric of the epidermis;
(2) a bonding step of bonding an epidermis to the base material by vacuum molding;
(3) an epidermis trimming step of cutting the periphery of the epidermis in accordance with the form of the base material; and
(4) a winding step of winding an epidermis after the epidermis trimming step.

According to the present invention, since the sewing pattern is provided at a site where the expansion rate at the time of vacuum molding is 130% or less or 110% or less, the load on the sewing hole of the sewing pattern at the time of vacuum molding can be reduced, and deformation and damage of the sewing hole can be reduced. Further, deformation and positional deviation of the form of the sewing pattern itself can also be reduced.

### BRIEF DESCRIPTION OF DRAWINGS

FIG. 1 is a cross-sectional view of an epidermis-bonded product 100 according to an embodiment.

FIG. 2 is a process chart showing a method of determining a sewing pattern of the epidermis-bonded product 100 according to the embodiment.

FIG. 3 is an explanatory view for describing an inclination of installing a base material 10 on a raw fabric 20 of an epidermis of the epidermis-bonded product 100 according to the embodiment.

FIG. 4 is a process chart showing a method of producing the epidermis-bonded product 100 according to the embodiment.

FIG. 5 is a view illustrating a state in which a sewing pattern 21 is applied to the epidermis 20 according to the embodiment.

FIG. 6 is an explanatory view illustrating part of a bonding step.

FIG. 7 is an explanatory view illustrating part of the bonding step.

### DESCRIPTION OF EMBODIMENTS

Hereinafter, a method of determining a sewing pattern according to an embodiment and a method of producing an epidermis-bonded product 100 in which an epidermis 20 having a sewing pattern 21 is bonded to a base material 10 will be described in detail with reference to the drawings. Note that the embodiment and drawings described below illustrate some of the embodiments of the present invention, are not used for the purpose of limiting to these configurations, and can be appropriately changed without departing from the gist of the present invention. In the drawings, corresponding components are denoted by the same or similar reference numerals.

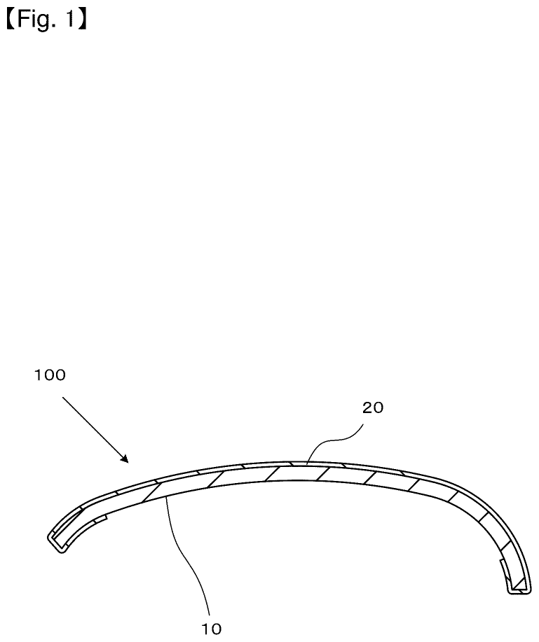

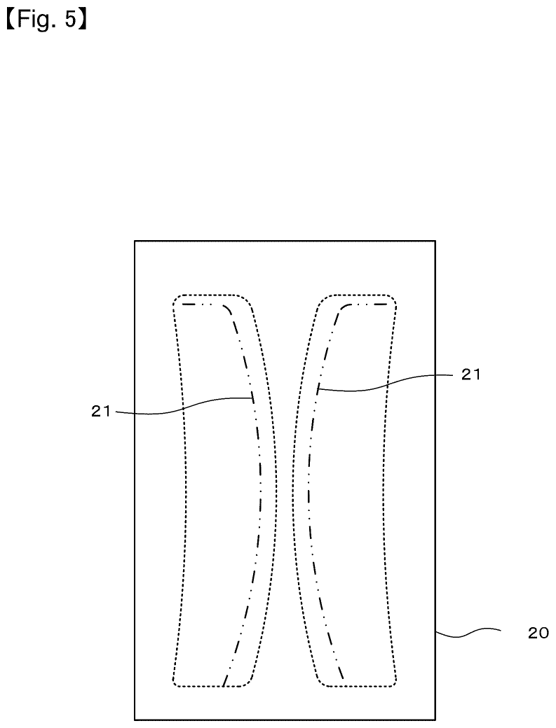

First, a method of determining the sewing pattern 21 (see FIG. 5) will be described. As illustrated in FIG. 1, in the sewing pattern 21 according to the present invention, when the epidermis-bonded product 100 formed by bonding the epidermis 20 to the surface of the base material 10 by vacuum molding is produced with respect to the base material 10 such as plastic or wood, the sewing pattern 21 for decoration may be applied to the epidermis. The method of determining the sewing pattern 21 is a method of determining how to provide the sewing pattern on the epidermis 20 of the raw fabric in order to prevent the sewing hole from expanding, sometimes the sewing hole from being broken, or the sewing pattern from changing when the epidermis 20 sewn in the method of producing the epidermis-bonded product 100 described later is molded by vacuum molding.

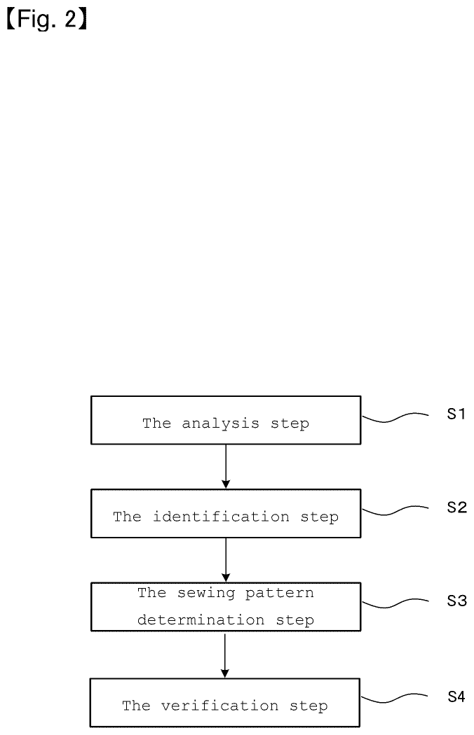

As illustrated in FIG. 2, the method of determining a sewing pattern according to the present invention mainly includes the following steps: (1) an analysis step (S1) of measuring and analyzing an expansion rate of an epidermis 20 when the epidermis 20 is vacuum-molded on a base material 10 by simulation analysis by a computer or by vacuum molding according to each base material installation direction of vacuum molding; (2) an identification step (S2) of identifying a range of an expansion rate of 130% or less according to each base material installation direction based on the measured expansion rate; and (3) a sewing pattern determination step (S3) of determining the sewing pattern 21 and the base material installation direction within a range of an expansion rate of 130% or less. Hereinafter, each step will be described in detail.

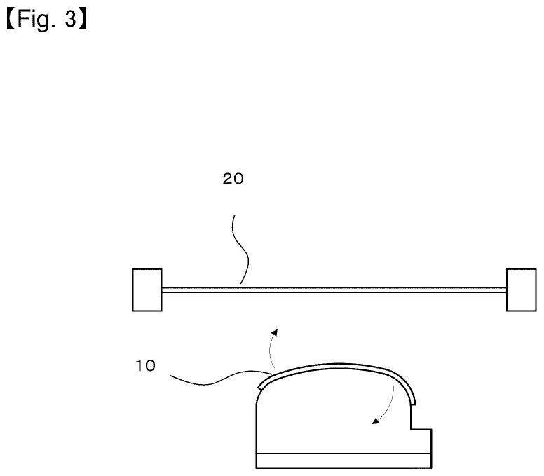

The analysis step (S1) is a step of analyzing the expansion rate of the epidermis 20 that expands when vacuum molding is performed by performing simulation analysis using a computer or by actually performing vacuum molding. The expansion rate indicates how lengths in the X direction and the Y direction in a certain range before vacuum molding expand after vacuum molding. For example, when the surface of the epidermis is divided into squares each having 1 cm×1 cm in the X direction×the Y direction, and the size of a certain square after vacuum molding is 1.2 cm×1.1 cm, the expansion rate is 120% in the X direction and 110% in the Y direction. Here, the expansion rate of 130% or less means that the expansion rate is 130% or less in both the X direction and the Y direction. The X direction and the Y direction are orthogonal to each other, and the X direction can be arbitrarily determined. The size of the square as a reference is not limited. Although the accuracy is increased by dividing a certain region into a larger number of squares, the work efficiency is deteriorated, and thus the division is selected from these viewpoints. In the analysis step, it is preferable to perform simulation analysis by a computer. By performing simulation analysis by a computer, a difference in expansion rate due to a difference in a base material installation direction in vacuum molding can be easily analyzed, and can be used as information when preparing a vacuum molding die. In the present specification and claims, the “base material installation direction” refers to an inclination at which the base material 10 is installed with respect to the raw fabric 20 of the epidermis as illustrated in FIG. 3, and the expansion rate of the epidermis 20 varies depending on how to make this inclination. Therefore, in order to analyze the optimum expansion rate, it is preferable to analyze the expansion rate according to the base material installation direction.

The identification step (S2) is a step of identifying a range in which the expansion rate is 130% or less based on the expansion rate measured in the analysis step. That is, by identifying a portion having an expansion rate of 130% or less in both the X direction and the Y direction, a region where expansion is small when vacuum molding is performed is identified.

The sewing pattern determination step (S3) is a step of determining a form of any sewing pattern for decoration in a range in which the expansion rate is 130% or less. The sewing pattern is not particularly limited, and various stitches such as a single stitch, a double stitch, and a design stitch can be selected. As a result of various studies, the present inventors have found that by providing stitches in a range where the expansion rate is 130% or less, it is possible to prevent hole expansion of the sewing hole and breakage of the hole at the time of vacuum molding, to suppress deformation of the form of the stitches, and to maintain the determined form of the sewing pattern. More preferably, the expansion rate is set to 110% or less. As described above, by using the sewing pattern and the base material installation direction determined so that the expansion rate is 130% or less or 110% or less, the hole expansion of the sewing hole and the breakage of the hole can be prevented at the time of vacuum molding, the deformation of the form of the stitch can be suppressed, and the deformation of the determined form of the sewing pattern can be reduced by the method of producing the epidermis-bonded product 100 to be described later.

Further, a verification step (S4) may be optionally provided. The verification step (S4) is a step of performing verification by preparing a vacuum molding die based on the base material installation direction after determining the base material installation direction and performing actual vacuum molding on the epidermis.

This is a step of preparing a vacuum molding die based on the base material installation direction derived by simulation analysis of a computer, and then verifying the expansion rate by vacuum molding the actual epidermis using this vacuum molding die. By such a step, an error from the expansion rate by computer simulation can be calculated, and a method of producing the epidermis-bonded product described later can be determined with higher accuracy.

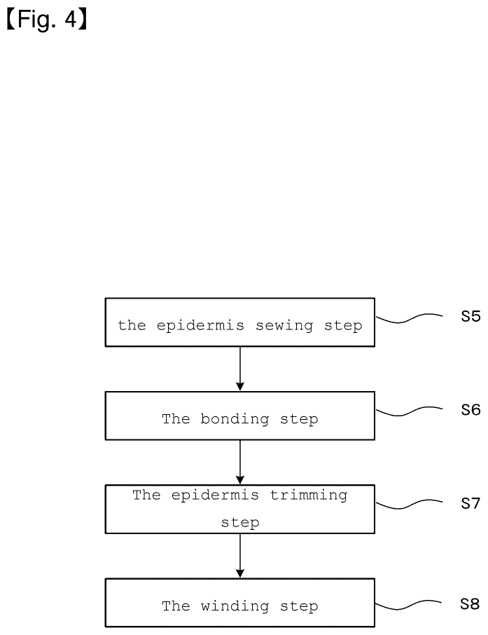

Next, a method of producing the epidermis-bonded product 100 according to the present invention will be described. As shown in FIG. 4, the method of producing the epidermis-bonded product 100 mainly includes the following steps: (1) an epidermis sewing step (S5) of sewing the sewing pattern into the raw fabric of the epidermis; (2) a bonding step (S6) of bonding an epidermis to the base material by vacuum molding; (3) an epidermis trimming step (S7) of cutting the periphery of the epidermis in accordance with the form of the base material; and (4) a winding step (S8) of winding an epidermis after the epidermis trimming step. Hereinafter, each step will be described in detail.

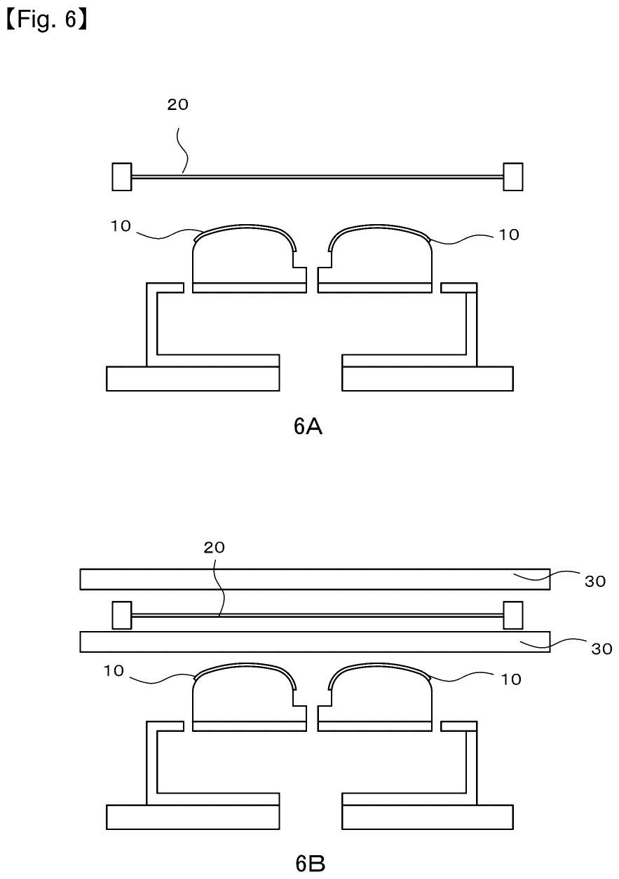

As illustrated in FIG. 6, the epidermis sewing step (S5) is a step of sewing the sewing pattern 21 for decoration determined in the previous step to the non-molded planar epidermis 20 with an automated pattern sewing machine. In the present invention, by performing the epidermis sewing step (S5) in a flat face state before the epidermis 20 is molded, sewing can be performed by the automated pattern sewing machine, and a large number of pieces can be simultaneously sewn from one large epidermis (FIG. 6 illustrates a two-piece state). Therefore, the uniformity and stabilization of the shape of the sewing pattern 21 can be achieved, and the production speed can be improved. Note that a two-dot chain line in FIG. 6 indicates the sewing pattern 21, a dotted line indicates a portion cut by assumed trimming, and actually, nothing is processed in the epidermis sewing step for the dotted line portion. The sewing pattern 21 is not particularly limited as long as sewing can be performed by a pattern sewing machine, regardless of whether it is manual or automated. In the present invention, since sewing is performed on a flat face epidermis, various sewing patterns 21 such as zigzag sewing, double sewing, and an embroidered pattern can be sewn even by a manual operation by an unskilled person or an automated pattern sewing machine. In particular, since the curved surface cannot be placed on the table of the sewing machine in the complicated curved surface or the small curved surface after molding, even a skilled operator cannot perform sewing in the double stitching or the embroidering. However, by performing sewing on a flat face, a complicated sewing pattern can be performed on the complicated curved surface or the small curved surface by an automated pattern sewing machine. As described above, the present invention is particularly effective when it is desired to provide a sewing pattern in a portion to be a curved surface when the epidermis-bonded product 100 is finally obtained, and even in such a portion, a sewing pattern can be formed without any problem if the portion has an expansion rate of 130% or less or 110% or less. The epidermis 20 is not particularly limited as long as it is a material that can be used for by vacuum molding. Examples thereof include olefin-based thermoplastic elastomers, PVC leather, and thermoplastic polyurethane. The surface of the epidermis may be decorated by leather processing or embossing.

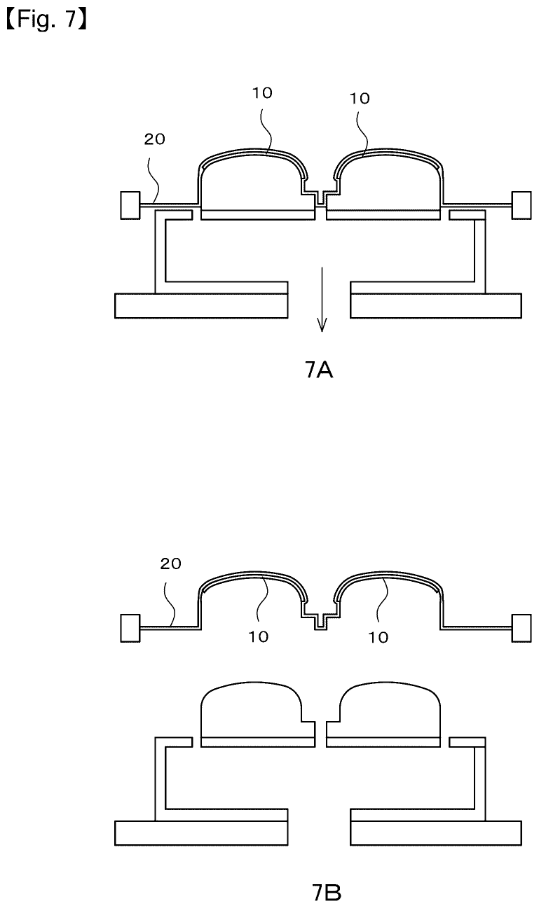

The bonding step (S6) is a step of bonding the epidermis 20 to the base material 10, and in the present invention, the epidermis molding step and the bonding step are performed simultaneously. Specifically, as illustrated in FIGS. 6 and 7, the epidermis 20 is fixed to the bonding surface side of the base material 10 (FIG. 6A). Next, the epidermis 20 is heated by a heater 30 (FIG. 6B). As a result, the epidermis 20 is flexible and easily follows the surface of the base material 10. Then, the epidermis 20 is drawn by vacuuming the back side of the base material 10, and the epidermis 20 is bonded to the surface of the base material 10 while being molded into the form of the base material 10 (FIG. 7A). Then, when the mold is released after cooling, the epidermis is molded into the form of the base material 10, and the epidermis 20 is bonded (FIG. 7B). At this time, it is preferable that the epidermis is located at a position similar to the location (position where the epidermis is fixed at the time of molding) used in the verification step, and the epidermis is bonded to the base material by vacuum molding. This is because locating at the same position makes it easy to reproduce the same expansion rate as in the verification step. As described above, in the present invention, by simultaneously performing the step of molding the epidermis 20 and the bonding step of bonding the base material 10 and the epidermis 20 in one step, it is possible to reduce the number of steps by two as compared with the case where the step of molding the epidermis 20 and the step of bonding the base material 10 and the epidermis 20 are separately performed as in the conventional method of producing an epidermis-bonded product. Therefore, the production speed can be improved, and the cost can be reduced. Further, in the conventional method of producing an epidermis-bonded product, since the epidermis 20 is bonded after being molded, the pressing step of the base material 10 and the epidermis 20 has to be performed one by one. However, in the present invention, since bonding is performed simultaneously with molding, a plurality of pieces can be molded and bonded simultaneously. By taking a large number of pieces in this way, the yield is improved as compared with the conventional case, which contributes to cost reduction. As the base material 10, plastic molded into a predetermined form by vacuum molding, injection molding, or the like, molded wood, or the like is usually used, but the material thereof is not limited thereto. An adhesive for bonding the epidermis 20 to the surface of the base material 10 may be optionally applied.

The epidermis trimming step (S7) is a step of cutting an extra portion of the epidermis 20 bonded to the base material 10 and separating a plurality of pieces that is simultaneously molded and bonded into individual pieces. The epidermis trimming step may be performed by machining.

The winding step (S8) is a step of winding the epidermis 20 protruding around the base material 10 to the back side and fixing the epidermis. The wound epidermis 20 is bonded to the back side of the base material 10 with an adhesive or fixed with a stapler or the like.

The epidermis-bonded product 100 is thus completed. The completed epidermis-bonded product 100 has an epidermis provided with the sewing pattern 21 that is sewn before molding. In particular, according to the method of producing the epidermis-bonded product 100 according to the present invention, the sewing pattern 21 can be provided regardless of the curvature of the convex curved surface, the concave curved surface, or the curved surface. Therefore, as compared with the conventional epidermis-bonded product to which the epidermis 20 having the sewing pattern 21 is bonded, the range of selection of the portion where the sewing pattern 21 can be provided can be widened, and the expansion and breakage of the sewing hole after vacuum molding can be prevented, and the deformation of the sewing pattern can also be reduced. In addition, it is also possible to provide a complicated sewing pattern 21 such as double stitching or embroidering on a complicated curved surface or a small curved surface, which cannot be conventionally provided.

Note that examples of the epidermis-bonded product 100 include automobile related components such as a door trim, an armrest, an ornament, and a console lid, and furniture such as a chair and a desk, but the present invention is not limited thereto, and may be applied to any product as long as the product functions as a product to which the epidermis is bonded.

Note that the present invention is not limited to the above-described embodiments at all, and it goes without saying that the present invention can be implemented in various modes as long as they fall within the technical scope of the present invention.

### INDUSTRIAL APPLICABILITY

As shown in the above-described embodiment, the present invention can be industrially used as a method of producing an automobile related component.

### REFERENCE SIGNS LIST

10 base material
20 epidermis
21 sewing pattern
30 heater
100 epidermis-bonded product

1. A sewing pattern determination method of determining a sewing pattern to be provided on an epidermis raw fabric before molding when producing a product in which an epidermis provided with a sewing pattern is integrated on a base material by vacuum molding, the method comprising;
(1) measuring and analyzing an expansion rate of the epidermis when the epidermis is vacuum-molded on the base material by simulation analysis using a computer or by vacuum molding according to each base material installation direction of vacuum molding;
(2) identifying a range of an expansion rate of 130% or less according to each base material installation direction based on the measured expansion rate; and
(3) determining a sewing pattern and a base material installation direction within a range of an expansion rate of 130% or less.

2. A sewing pattern determination method of determining a sewing pattern of pre-molding sewing in which a sewing pattern is provided on an epidermis when producing a product in which an epidermis provided with a sewing pattern is vacuum-molded on a base material, the method comprising:
(1) measuring and analyzing an expansion rate of the epidermis when the epidermis is vacuum-molded on the base material by simulation analysis using a computer or by vacuum molding according to each base material installation direction of vacuum molding;
(2) identifying a range of an expansion rate of 110% or less according to each base material installation direction based on the measured expansion rate; and
(3) determining a sewing pattern and a base material installation direction within a range of an expansion rate of 110% or less.

3. The sewing pattern determination method according to claim 1, further comprising preparing a vacuum molding die based on the base material installation direction after determining the base material installation direction, and verifying the epidermis by actual vacuum molding.

4. A production method of producing an epidermis-bonded product according to the sewing pattern determined by the sewing pattern determination method according to claim 3, the production method comprising:
(1) sewing the sewing pattern to a raw fabric of the epidermis;
(2) bonding the epidermis to the base material by vacuum molding;
(3) epidermis trimming by cutting a periphery of the epidermis in accordance with a form of the base material; and
(4) winding the epidermis after the epidermis trimming.

5. The sewing pattern determination method according to claim 2, further comprising preparing a vacuum molding die based on the base material installation direction after determining the base material installation direction, and verifying the epidermis by actual vacuum molding.

6. A production method of producing an epidermis-bonded product according to the sewing pattern determined by the sewing pattern determination method according to claim 5, the production method comprising:
(1) sewing the sewing pattern to a raw fabric of the epidermis;
(2) bonding the epidermis to the base material by vacuum molding;
(3) epidermis trimming by cutting a periphery of the epidermis in accordance with a form of the base material; and
(4) winding the epidermis after the epidermis trimming.
